(19) United States
(12) Patent Application Publication
(10) Pub. No.: US 2005/0136918 A1
(43) Pub. Date: Jun. 23, 2005

(54) Methods and apparatuses for alert driven transactions

(76) Inventors: George Kakatsakis, Boulder, CO (US); Frank Vernon, Boulder, CO (US); Carl Herrmann, Longmont, CO (US)

Correspondence Address: HOLLAND & HART, LLP, 555 17TH STREET, SUITE 3200, DENVER, CO, 80201, US

(21) Appl. No.: 10/740,019

(22) Filed: Dec. 18, 2003

(51) Int. Cl. H04Q 7/20

(52) U.S. Cl. 455/432.3

(57) ABSTRACT

The present invention provides a system capable of generating an alert to a user based on predetermined conditions of set in a user account. The alert includes a set of instruction whereby the user can regulate the user account based on the alert.

### FIELD OF THE INVENTION

The present invention relates to alert driven transactions and, more particularly, methods and apparatuses for alerting a user regarding a predetermined condition and offering the purchase of products or services based on the predetermined condition.

### BACKGROUND OF THE INVENTION

Calling plans are a very popular device for purchasing a preset number of calling minutes for wireless telephone plans. Many, if not most, of these plans involve purchasing the wireless service and a preset number of connect minutes. The preset number of connect minutes can take a number of different forms, such as, for example, 1000 minutes a month, 200 weekday minutes with 1500 weekend minutes, 100 text messages a month, or the like.

Unfortunately, situations often arise with the preset calling plans that cause consumer dissatisfaction. One situation involves the user not using all of the prepaid allotted minutes. Another situation occurs when the user exceeds the prepaid allotted minutes. Both of these are examples of situations providing less than optimal use of resources.

In the first situation, the user may pay for 1000 minutes a month, but only use some number less than 1000 minutes, say 700 minutes. Thus, the user purchased 300 minutes of connect time, which is wasted. Some calling plans attempt to correct this by “rolling over” the minutes to the next month. Many people purchase more minutes than they need to ensure they don't have to pay penalty rates for connect time over their allotted minutes. Even with the advent of roll over plans, many users purchase connect minutes that are wasted.

In the second situation, the user may pay for the same 1000 minutes a month, but use some number of minutes more than the prepaid allot 1000 minutes, say 1258 minutes. Often times, the user goes over the paid for 1000 minutes without even knowing. The overage of 258 minutes of connect time is frequently charged at penalty prices. When users unknowingly exceed the prepaid allotted minutes, they are frequently surprised if not alarmed by the monthly invoice.

Even with the roll over provisions, most users find themselves in the unenviable position of either purchasing more minutes a month than typically used or paying penalties for exceeding the allotted time. In other words, it would be desirous to provide methods and/or apparatuses to alert a user when the user was approaching a connect limit and offering the user the options of not using the phone, purchasing additional minutes, or paying the penalty. With this system, the user could purchase a connect plan with a prepaid number of minutes more closely resembling the number of minutes typically used a month without worrying about over use penalties.

### SUMMARY OF THE INVENTION

To attain the advantages and in accordance with the purpose of the invention, as embodied and broadly described herein, the present invention provides a method for alert driven transactions. The method comprises receiving information from a provider relating to an account of the user. Based on the information, it is determined whether an alert should be generated. If it is determined the alert should be generated, an outbound message is generated and delivered to a user. After the outbound message is sent to the user, it is determined whether a reply is received. Based on the reply, an account update signal is created and transmitted to the provider. The provider updates the user account based on the account update signal.

The present invention also provides apparatuses for alert driven transactions. The apparatuses comprise a message engine including an outbound message engine, an inbound message engine, and a message handler. A rules engine containing at least one rule template, and a processor coupled to the message engine and rules engine. In this apparatus, the processor uses information regarding a user's account and compares the information to the at least one rule template in the rules engine. Based on the comparison, the processor may create an outbound message that the processor delivers to the message engine for transmission to the user by the outbound message engine. The processor instructs the inbound message engine to anticipate a reply to the outbound message. When the reply is received, an account update signal is generated and sent to the provider to update the user account.

The present invention still further provided a computer program product having a computer usable medium including computer readable code embodied therein for providing an alert driven transation. The computer program includes an information receiving module configured to receive information relating to a user account. Based on the information received, an alert determining module is configured to determine whether an alert should be generated. An outbound message generating module is configured to generate an outbound message when it is determined by the alert determining module that the alert should be generated as an outbound message. The outbound message is delivered using a delivering module configured to deliver the outbound message to a user. The user replies to the message and a reply delivering module is configured to determine whether a reply is received from the user in response to the delivered outbound message. The reply is used by an account update signal module that configured to create an account update signal, which is usable to update the user account based on the reply received by the reply delivering module.

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIG. 1 is a diagrammatic representation of one possible system architecture consistent with the present invention;

FIG. 2 is a sample memory associated with the carrier of FIG. 1 for tracking user connect time;

FIG. 3 is a diagrammatic representation of one possible alert server associated with FIG. 1; and

FIG. 4 is a flowchart representation of one method for alert driven transactions consistent with the present invention.

### DETAILED DESCRIPTION

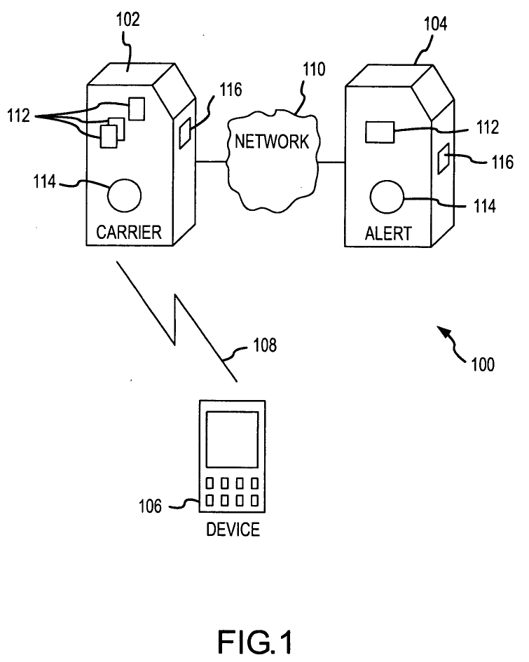

The present invention will be described with reference to FIGS. 1 to 4. While the present invention will be described with particularity in relation to connect minutes relating to wireless telephone service, it should be understood that the present invention could be used in many other applications, some of which will be mentioned below, and the references to particular uses should be considered exemplary and non-limiting.

Referring first to FIG. 1, a system 100 is shown. System 100 includes a provider server 102, an alert server 104, and a wireless device 106. Wireless device 106 can be, for example, a cellular telephone, a personal digital assistant (PDA), an electronic game, a pager, or the like. In this example, provider server 102 is a conventional wireless carrier, such as Version, Sprint, AT&T, or the like. Provider server 102 and wireless device 106 are connected over communication link 108 using conventional wireless protocols. Provider server 102 and alert server 104 are connected through network 110. Network 110 can be a local area network, conventional bus work, a universal serial bus, fiber optics, a wide area network, an Ethernet, an Internet, the World Wide Web, a wireless network, or the like. As used herein, the term server is used generically to mean any style of processor or CPU, such as, for example, chip sets, a mainframe style computer, a personal computer, a laptop, a network server, a personal workstation, a handheld computer, and the like. Further, while provider server 102 and alert server 104 are described as discrete components, one of ordinary skill in the art would recognize on reading the disclosure alert server 104 could as easily be integrated into provider server 102 making one integrated unit. For convenience, however, provider server 102 and alert server 104 will be described as separate components. As the present invention is described with regard to wireless plans, provider server 102 may sometimes be referred to as carrier server.

Provider server 102, while shown as a single unit, could be a number of networked processors 112, memories 114 (such as SRAM, DRAM, ROM, and the like), and other peripheral devices 116 (such as monitors, displays, printers, tape drives, and the like). Alert server 104 could also be a series of networked processors 112, memories 114, and other peripheral devices 116, but it is believed alert server 104 could function using a single conventional server or personal computer processor.

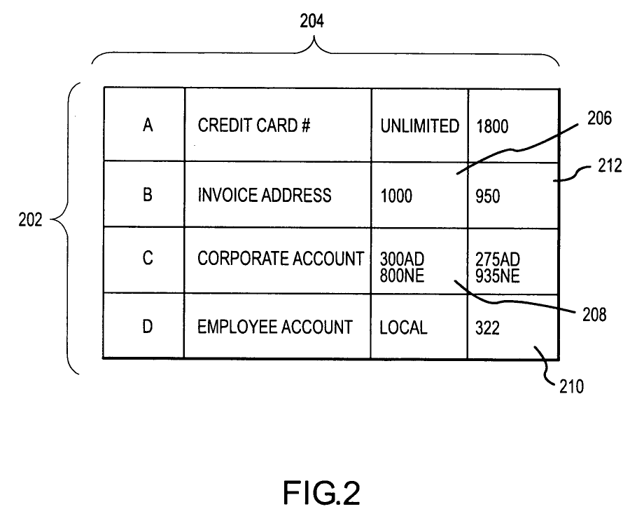

The interaction between provider server 102 and wireless device 106 is well know in the art and will not be further explained herein except as it relates to the present invention. One conventional feature of provider server 102 is that it monitors connect time for wireless device 106. For example, FIG. 2 represents a portion of memory 200 connected to or contained in one or more memories 114 of provider server 102. Memory 200 can be represented by a spreadsheet having a plurality of rows 202 and columns 204. While shown as a database structure, memory 200 can take any number of formats, such as cache memory, buffer memory, unformatted memory, or the like. In this example, rows 202 generally represent accounts, of which four accounts A, B, C, and D are shown, and columns 204 represent information fields, such as, account identifier, billing information, plan information, such as the 1000 minute plan shown in cell 206, or the 300 weekday 800 weekend minute plan shown in cell 208, connect time, such as cell 210 showing account D has been connected 322 minutes, etc. As mentioned above, carrier server 102 conventionally tracks connect minutes for billing and will not be further explained herein. Also, memory 200 is representative and other, more, or less, information could be stored in memory 200 as a matter of design choice.

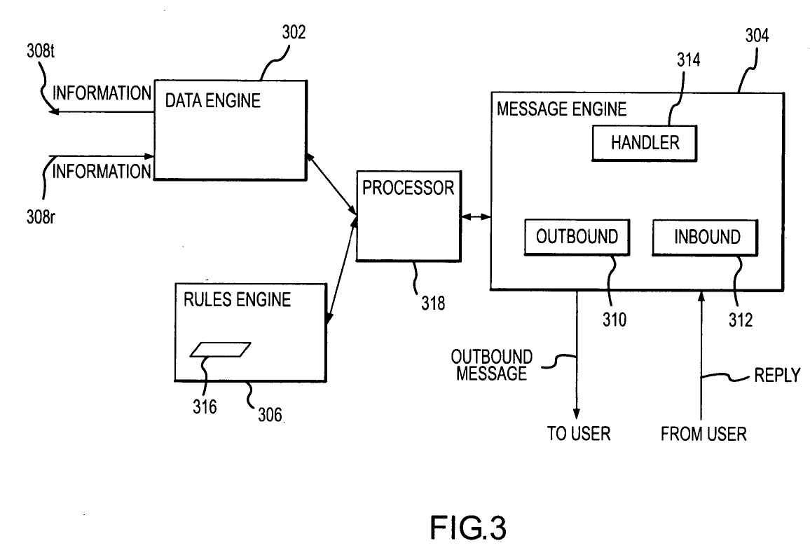

Referring now to FIG. 3, alert server 104 will be explained in more detail. As explained above, alert server 104 will be described as separate from provider server 102. Alert server 104 comprises a data engine 302, a message engine 304, and a rules engine 306. While shown as discrete components, the components of alert server 104 could be integrated into a single unit. If provided as discrete components, one of skill in the art would recognize on reading the disclosure that the various discrete components could be located remote from each other.

Data engine 302 comprises an interface between alert server 104 and carrier server 102. Data engine 302 provides a link between processes, routines, and software modules contained in alert server 104 and information, processes, routines, and software modules contained in provider server 102. If alert server 104 was integrated into provider server 102, data engine 302 could be eliminated as the processes, routines, and software modules contained in alert server 104 could access processes, routines, and software modules contained in provider server 102 directly. When data engine 302 is employed; however, data engine 302 receives information 308r from provider server 102 or polls carrier server 102 for information 308r, as will be explained further below. Provider server 102 may provide data engine 302 information relating to, for example, account names, account addresses, email addresses, text message numbers, phone numbers, plan information including plan minutes, plan minutes remaining (or some derivative, such as percentage of minutes used, total minutes used, etc.), account history, or other information as desired. Data engine 302 not only receives information 308r from provider server 102, but also transmits information 308t to provider server 102, which will be explained further below as well. Information transmitted to provider server 102 may include, for example, responses to various alerts sent by alert server 104. The terms transmit and receive should be construed broadly to include transmitting and receiving data between discrete components of a system, such as, for example, if alert server 104 and provider server 102 are separate servers, as well as transmitting and receiving data between an integrated system, such as, for example, if alert server 104 and provider server 102 are integrated units.

Data engine 302 may perform conversions to map data between various protocols. For example, data 308r may be in a WAP protocol and data engine 302 may convert the data 308r into a HTML protocol usable by alert server 104. Moreover, data 308t will be converted from HTML protocol used by alert server 104 to the protocol used by provider server 102, which may be WAP. Other protocols as are generally known in the art are possible. Further, data conversions are generally known in the art and will not be further explained herein. Again, if alert server 104 is integrated into provider server 102, protocol conversion is un-necessary and data engine 302 could be eliminated.

Message engine 304 comprises an outbound message engine 310, an inbound message engine 312, and a message handler 314. Outbound message engine 310 sends messages to wireless device 106, which may be voice messages, email messages, text messages, or the like. Inbound message engine 312 receives reply messages generated from wireless device 106 in response to the outbound message. The reply messages could be voice messages, email messages, text messages, or the like. Transmission between message engine 304 and wireless device 106 uses conventional transmission protocols, which will not be further explained herein.

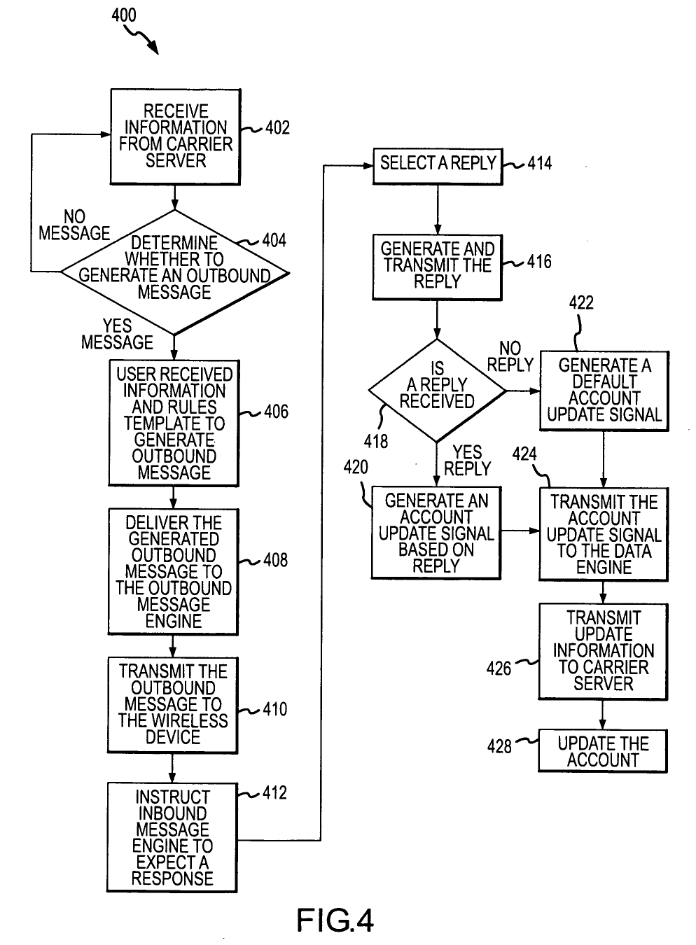

Rules engine 306 comprises one or more rule templates 316, which could be a number of programs, routines, processes, and the like. A central processing unit 318, which could be a portion of one of the servers, a dedicated computer, a CPU, a processor, a chip set, or the like, coordinates the various parts, as will be explained further with respect to flowchart 400, see FIG. 4. If alert server 104 was integrated into provider server 102, data engine 302 could be eliminated and information 308t and 308r could be transmitted and received by processing unit 318.

Rules engine 306 uses received information 308r and a number of predefined rules stored in templates 316 to generate an outbound message. Based on the rule and received information 308r, rules engine 306 provides the generated outbound message that outbound message engine 310 sends to wireless device 106. The outbound message is sent in a conventional manner and will not be further explained.

The various components of alert server 104 can be connected using conventional bus works, printed circuit boards, or other conventional connectivity devices.

Referring now to FIG. 4, data engine 302 receives information 308r from carrier server 102 relating to a customer account, step 402. Information 308r could be transmitted from carrier server 102 because predetermined conditions have been achieved, such as, for example, account B (FIG. 2) has used 95% of the account's connect minutes, account B has used 950 connect minutes, account B has 50 connect minutes remaining. Alternatively, data engine 302 could poll carrier server 102 for information 308r. Other and more complex queries are of course possible.

Alternatively to polling for particular information, carrier server 102 could set flags in memory 200. Alert sever 104 would poll (monitor) memory 200 for the flags and generate messages based on the flags.

Processor unit 318 determines whether it should generate an outbound message by comparing received information 308r to rule templates 316, step 404. If received information 308r does not require processor 318 to generate an outbound message, the system waits for the next received information, step 402. If received information 308r does require processor 318 to generate an outbound message, processor 318 uses rule template 316 to generate an outbound message, step 406. The generated outbound message is delivered to the outbound message engine 310, step 408, and the outbound message is transmitted to wireless device 106, step 410. Alert server 104 could transmit the outbound message, but because of the many different protocols associated with different carriers, it is likely easier for alert server 104 to relay the outbound message to carrier server 102 over network 110 for transmission to wireless device 106. Generally, transmission of the outbound message, be it a voice, text, or email message, is performed in any manner currently known in the art.

The outbound message is transmitted to wireless device 106, step 410. While the outbound message could simply be a message, such as you have used over 80% of you prepaid connect time, typically, the outbound message could provide options for a reply or a response. For example, referring to account C (FIG. 2), the user has prepaid for 300 weekday minutes and 800 weekend minutes. If, for example, the user has used 275 weekday minutes and 700 weekend minutes, the outbound message may be something like one of the following:
You have used over 90% of your weekday minutes, if you would like to purchase 50 additional weekday minutes press 1, if you would like to purchase 100 additional weekday minutes press 2, if you would like to purchase 0 additional weekday minutes press 3.
You have used over 90% of your weekday minutes and over 85% of your weekend minutes, if you would like to purchase 25 additional weekday minutes press 1, if you would like to purchase 50 additional weekend minutes press 2, if you would like to purchase 25 additional weekday minutes and 50 additional weekend minutes press 3, if you would like to purchase 0 minutes press 4.
You have used over 90% of your weekday minutes and over 85% of your weekend minutes, if you would like to purchase 25 additional weekday minutes press 1, if you would like to purchase 50 additional weekend minutes press 2, if you would like to purchase 25 additional weekday minutes and 50 additional weekend minutes press 3, if you would like to purchase 0 minutes press 4, if you would like to disable the reminder feature this month press 5.
   Many different types of messages and replies are possible. Based on the outbound message, the processor 318 instructs message engine 304 to expect a particular reply to the outbound message, step 412. The user of wireless device 106, would receive the outbound message, and select an appropriate reply, which could include ignoring the message, step 414. The reply is generated and transmitted by the wireless device to inbound message engine 312, step 416. The inbound message engine determines whether an appropriate reply is received, step 418, which was previously instructed to expect particular responses. If the inbound message engine determines a reply was received, the message handler generates an account update signal based on the reply, step 420. If the inbound message engine determines a reply was not received or an inappropriate reply was received, the message handler generates an account update signal based on default setting, step 422. The message handler transmits the account update signal to data engine 302, step 424. Data engine 302 transmits account update information 308t to carrier server 102, step 426. Carrier server 102 then updates the account to reflect the transaction, step 428.

Flowchart 400 reflects using a default response when no reply or an incorrect reply is received. Other options for no reply or an incorrect reply could include regenerating the outbound message. In the second transmission, the instruction in the outbound message instruct the user that if no reply is received, the system will assume a particular response.

Using the alert driven transactions, wireless device users can manage their account. In particular, the user could purchase additional minutes at rates greater than plan rates, but less than penalty rates. Alternatively, the user could elect to turn the account off for the remainder of the month. Still alternatively, the user could elect not to purchase additional minutes and risk the inflated penalty rates. Another alternative is the user may elect to upgrade the plan to a higher number of prepaid connect minutes. Regardless of the choice, of which only a few are shown, the user is aware of the account and can optimally manage the account. Further, the user can purchase a plan more attuned to the user's conventional usage without risk of being surprised by penalty minutes.

Although the present invention has been explained with specific reference to cellular phones and connect minutes, other uses of the present invention are possible. For example, a user could have a prepaid calling card allowing a particular number of user minutes. When the number of used user minutes exceeds a predetermined value, a phone call may be established using the POTS system to provide an alert that the user is approaching his predefined number of minutes. The phone call may request various responses, such as, add 30 minutes to the calling card account, or the like.

Alternatively, a bank may use the present invention to alert a customer that, for example, a customer's checking account has fallen below a predetermined minimum balance. In this case, the replies may include, transfer money from another account to the checking account, purchase overdraft protection, or the like. Credit cards could use a similar function for account overages, etc.

Still further, the present invention may be used in more routine tasks. For example, a blockbuster account may send an alert to a user when a new release is available. In this case, the reply may be to reserve the new release until the customer can arrive at the store to rent the new release.

Although the above provides examples with a retail or residential customer, businesses could benefit from the present invention. For example, a grocery store could have an inventory system that provides an alert to the stock manager when, for example, 1% milk inventories is below 50 cartons. The offered replies in this case, could be generate a special purchase order of 25 cartons, wait for standard delivery, transfer 25 cartons for another store, or the like.

Stockbrokers and dealers could also use the above invention. In particular, most accounts typically have preset sell and buy orders to avoid catastrophic losses or the like. Using the present invention, instead of preset sell and buy orders, an alert can be sent to the account manager indicating, the stock of XYZ company has fallen to $23/share, the requested replies could be press 1 to sell all shares, press 2 to sell X number of shares (which could be a number, like 50 shares, or a percentage, like 30% of shares), or the like.

While the invention has been particularly shown and described with reference to an embodiment thereof, it will be understood by those skilled in the art that various other changes in the form and details may be made without departing from the spirit and scope of the invention.

1. A method for alert driven transactions, comprising the steps of:
receiving information from a provider relating to an account of a user;
determining whether an alert should be generated based on the received information;
generating an outbound message for transmission to the user if it is determined the alert should be generated;
delivering the outbound message to the user;
determining whether a reply is received;
creating an account update signal based on the received reply if it is determined the reply was received; and
transmit the account update signal to the provider, wherein
the account of the user is updated based the received reply.

2. The method according to claim 1, wherein the step of receiving information from a provider comprises polling the provider for the information.

3. The method according to claim 1, wherein the step of determining whether an alert should be generated comprises the step of comparing the received information to a rule set comprised of at least one rule.

4. The method according to claim 1, wherein the step of delivering the outbound message to the user comprises at least one of a text message, a voice message, and an email message.

5. The method according to claim 1, wherein the step of generating the outbound message includes providing a reply set of at least one reply instruction.

6. The method according to claim 1, further comprising the step of instructing an inbound message engine to wait for the reply.

7. The method according to claim 6, further comprising the step of:
generating a default reply if it is determined that the reply is not received; and
creating an account update signal based on the default reply.

8. The method according to claim 1, further comprising the step of:
generating a second outbound message if it is determined that the reply is not received.

9. The method according to claim 1, wherein the provider is a wireless service provider.

10. A method for alert driven transactions, comprising the steps of:
receiving information from a wireless cellular carrier indicating an amount of non penalty time remaining in an account of a user;
generating an outbound message for transmission to the user indicating the amount of non penalty time remaining on the account and providing at least one reply option for modifying the account of the user;
transmitting the outbound message to the user;
determining whether the at least one reply is received from the user; and
modifying the account of the user based on the at least one reply.

11. The method according to claim 9, wherein the amount of non penalty time remaining in an account of the user comprises information consisting of a number of minutes used in a plan, a number of minutes left in a plan, a percentage of time left in the plan, and a percentage of time used in the plan.

12. An apparatus for generating alert driven transactions, the apparatus comprising:
a data engine, the data engine receives information from a provider server relating to an account of a user maintained by the provider server;
a message engine, the message engine is coupled to the data engine and comprises an outbound message engine, an inbound message engine, and a message handler;
a rules engine, the rules engine is coupled message engine and comprises at least one rule template;
a processor coupled to the data engine, the message engine, and the rules engine for coordinating the data engine, the message engine, and the rules engine;
the processor uses the information received by the data engine and compares the information to the at least one rule template and generates an outbound message based on the comparison;
the outbound message engine transmits the outbound message generated by the processor to the user;
the inbound message engine receives a reply the user sends in response to the outbound message;
the inbound message engine uses the reply to generate an account update signal; and
the data engine transmits the account update signal to the provider server to update the account of the user.

13. The apparatus of claim 12, wherein the data engine translates the data between a first protocol usable by the provider server and a second protocol used by the processor.

14. The apparatus of claim 12, wherein the provider server comprises a wireless service provider.

15. The apparatus according to claim 14, wherein the at least one rule template comprises information relating to connect minutes.

16. A computer program product comprising:
a computer usable medium including computer readable code embodied therein for processing information relating to a user account to generate an outbound message based on the information and receive a reply usable to update the user account, the computer usable medium comprising:
an information receiving module configured to receive information relating to a user account;
an alert determining module configured to determine whether an alert should be generated based on the information received by the information receiving module;
an outbound message generating module configured to generate an outbound message when it is determined by the alert determining module that the alert should be generated as an outbound message;
a delivering module configured to deliver the outbound message to a user;
a reply delivering module configured to determine whether a reply is received from the user in response to the delivered outbound message; and
an account update signal module configured to create an account update signal usable to update the user account based on the reply received by the reply delivering module.

17. The computer program product according to claim 16, wherein the information receiving module is configured to poll the user account to obtain information relating to the user account.

18. The computer program product according to claim 16, further comprising:
a rules module configured to store at least one rule template usable to determine when an alert should be generated; and
wherein the alert determining module is configured to compare the information received by the information receiving module to at least one rule template stored in the rules module.

19. The computer program product according to claim 16, wherein the outbound message generating module is configured to generate a message comprising at least one of a text message, a voice message, and an email message.

20. The computer program product according to claim 19, wherein the outbound message generating module is further configured to generate a message with a peply set of at least one reply instruction.
